(19) United States
(12) Patent Application Publication
(10) Pub. No.: US 2023/0170677 A1
(43) Pub. Date: Jun. 1, 2023

(54) WIRE HARNESS

(71) Applicant: SUMITOMO WIRING SYSTEMS, LTD., Yokkaichi-shi (JP)

(72) Inventors: Kosuke TANAKA, Yokkaichi-shi (JP); Katsutoshi IZAWA, Yokkaichi-shi (JP); Ryuta SAITO, Yokkaichi-shi (JP)

(73) Assignee: SUMITOMO WIRING SYSTEMS, LTD., Yokkaichi-shi (JP)

(21) Appl. No.: 17/989,331

(22) Filed: Nov. 17, 2022

(30) Foreign Application Priority Data
Nov. 26, 2021 (JP) 2021-192267

(51) Int. Cl. H02G 3/04; H02G 3/06; B60R 16/02

(52) U.S. Cl. CPC H02G 3/0406; H02G 3/0462; H02G 3/06; B60R 16/0215

(57) ABSTRACT

A wire harness including a wire harness main body having an electric wire and an exterior tube that covers an outer circumferential surface of the electric wire; a path restrictor that is attached to an outer circumferential surface of the exterior tube and restricts a path of the wire harness main body and an attachment attached to an outer circumferential surface of a portion in a lengthwise direction of the path restrictor.

### BACKGROUND

The present disclosure relates to a wire harness.

Conventionally, a wire harness that includes: a wire harness main body that includes an electric wire member and an exterior member that covers the electric wire member; and a path restricting member that is attached to an outer circumferential surface of the exterior member and is configured to restrict the path of the wire harness main body, has been known as a wire harness for a vehicle (for example, see JP 2019-53894A).

### SUMMARY

Incidentally, in the above-described wire harness, the path restricting member is attached to an attachment member such as another path restricting member in some cases, and in such a case, it is desirable that rattling does not occur at the portion where the path restricting member and the attachment member are attached. Note that rattling of the attachment portion causes damage to the attachment portion due to vibration or the like, for example.

An exemplary aspect of the disclosure provides a wire harness capable of suppressing rattling.

The wire harness of the present disclosure includes: a wire harness main body having an electric wire and an exterior tube that covers an outer circumferential surface of the electric wire; a path restrictor that is attached to an outer circumferential surface of the exterior tube and restricts a path of the wire harness main body; and an attachment attached to an outer circumferential surface of a portion in a lengthwise direction of the path restrictor, wherein: the path restrictor includes a main body that covers a portion of the outer circumferential surface of the exterior tube, and an insertion port that is open in a direction orthogonal to a lengthwise direction of the main body and extends over an entire length in the lengthwise direction of the main body, the path restrictor has a connection connected to the attachment, the attachment has a cover that covers an outer circumferential surface of the connection, the cover includes a receiver that covers a portion in a circumferential direction of the path restrictor, a lid that covers an entirety of the outer circumferential surface of the path restrictor together with the receiver, in the circumferential direction, and a joint at which the receiver and the lid are joined together, and the receiver and the lid sandwich the path restrictor.

According to the wire harness of the present disclosure, an effect of suppressing rattling is exhibited.

### BRIEF DESCRIPTION OF THE DRAWINGS

FIG. 1 is a schematic configuration diagram showing a wire harness of an embodiment.

FIG. 2 is a schematic perspective view showing a wire harness of an embodiment.

FIG. 3 is a schematic exploded perspective view showing a wire harness of an embodiment.

FIG. 4 is a schematic exploded perspective view showing a wire harness of an embodiment.

FIG. 5 is a schematic transverse cross-sectional view showing a wire harness of an embodiment.

FIG. 6 is a schematic exploded cross-sectional view showing a wire harness of an embodiment.

FIG. 7 is a schematic cross-sectional view showing a wire harness of an embodiment.

FIG. 8 is a schematic transverse cross-sectional view showing a wire harness of a modified example.

### DETAILED DESCRIPTION OF EMBODIMENTS

### Description of Embodiments of Present Disclosure

First, embodiments of the present disclosure will be listed and described.

[1] The wire harness of the present disclosure includes: a wire harness main body having an electric wire member and an exterior member that covers an outer circumferential surface of the electric wire member; a path restricting member that is attached to an outer circumferential surface of the exterior member and restricts a path of the wire harness main body; and an attachment member attached to an outer circumferential surface of a portion in a lengthwise direction of the path restricting member, in which the path restricting member includes a main body portion that covers a portion of the outer circumferential surface of the exterior member, and an insertion port that is open in a direction orthogonal to a lengthwise direction of the main body portion and extends over the entire length in the lengthwise direction of the main body portion, the path restricting member has a connecting portion connected to the attachment member, the attachment member has a covering portion that covers an outer circumferential surface of the connecting portion, the covering portion includes a receiving portion that covers a portion in a circumferential direction of the path restricting member, a lid portion that covers the entirety of the outer circumferential surface of the path restricting member together with the receiving portion, in the circumferential direction, and a joining portion at which the receiving portion and the lid portion are joined together, and the receiving portion and the lid portion sandwich the path restricting member.

According to this configuration, the connection portion of the path restricting member and the covering portion of the attachment member are provided so as to overlap each other in the lengthwise direction of the wire harness body. At this time, in the covering portion, the outer circumferential surface of the path restricting member is covered by the receiving portion and the lid portion, and the receiving portion and the lid portion are joined together. In this way, for example, the lid portion is formed in one piece with the receiving portion via a thin hinge portion, and rattling between the receiving portion and the lid portion is suppressed compared to a configuration in which the lid portion is locked to the receiving portion by engagement of a claw portion in the closed state. That is, in the configuration having a thin hinge portion and a claw portion, the receiving portion and the lid portion are likely to rattle at each part of the hinge portion and the claw portion, but it is possible to suppress the occurrence of such rattling with the configuration in which the receiving portion and the lid portion are joined to each other. Accordingly, the path restricting member can be sandwiched between the receiving portion and the lid portion without rattling, and rattling between the path restricting member and the attachment member can be suppressed.

[2] It is preferable that the joining portion is a portion at which the receiving portion and the lid portion are welded together.

According to this configuration, the receiving portion and the lid portion are joined to each other by welding. For this reason, the receiving portion and the lid portion can be joined together without interposing another member such as an adhesive between the receiving portion and the lid portion. Accordingly, it is possible to suppress an increase in the number of parts in the covering portion.

[3] It is preferable that the receiving portion includes a first fixing portion that protrudes outward in a radial direction of the covering portion from an end portion in the circumferential direction of the receiving portion, the lid portion includes a second fixing portion that protrudes outward in a radial direction of the covering portion from an end portion in the circumferential direction of the lid portion, and overlaps with the first fixing portion, and the joining portion is a portion at which the first fixing portion and the second fixing portion are welded together.

According to this configuration, the first fixing portion that protrudes radially outward from the end in the circumferential direction of the receiving portion, and the second fixing portion that protrudes radially outward from the end in the circumferential direction of the lid portion are joined together by being welded. This makes it possible to provide the welded portion at a position located away from the inner space of the covering portion. For this reason, the welded portion can be provided at a position located away from the electric wire member accommodated in the inner space of the covering portion. Accordingly, for example, it is possible to suitably suppress a case in which the energy (heat, etc.)

applied from the energy source (heat source, etc.) to the welded portion when welding the first fixing portion and the second fixing portion is applied to the electric wire member. As a result, it is possible to suitably suppress damage to the electric wire member.

[4] It is preferable that the first fixing portion overlaps with the second fixing portion in a direction orthogonal to a protruding direction of the first protruding portion.

According to this configuration, the first fixing portion and the second fixing portion overlap each other in a direction not facing the inner space of the covering portion, and the overlapped first fixing portion and second fixing portion are welded together. As a result, for example, it is possible to more suitably suppress a case in which the energy applied from the energy source to the welded portion when welding the first fixing portion and the second fixing portion is applied to the electric wire member. As a result, damage to the electric wire member can be more suitably suppressed.

[5] It is preferable that the joining portion is portions at which end surfaces on both sides in the circumferential direction of the receiving portion and end surfaces on both sides in the circumferential direction of the lid portion are welded together.

According to this configuration, the end surfaces on both sides in the circumferential direction of the receiving portion and the end surfaces on both sides in the circumferential direction of the lid portion are welded together. For this reason, the receiving portion and the lid portion can be joined together by welding without providing a portion protruding outward in the radial direction of the covering portion to the receiving portion and the lid portion. As a result, it is possible to suitably suppress an increase in the size of the covering portion in the radial direction.

[6] It is preferable that the joining portion is provided so as not to overlap with the insertion port and so as to overlap with the main body portion in the radial direction of the covering portion.

According to this configuration, the main body portion of the path restricting member can be interposed between the wire harness body and the joining portion in the radial direction of the covering portion. As a result, the main body portion of the path restricting member can receive spattered material that may occur during welding, for example, and therefore damage to the wire harness main body due to spattering can be suitably suppressed.

[7] It is preferable that a tightening margin is provided between the outer circumferential surface of the path restricting member and an inner circumferential surface of the covering portion.

According to this configuration, the path restricting member is fitted to the inner circumferential surface of the covering portion with a tightening margin. That is, when the path restricting member is fitted inside the covering portion, the outer circumferential surface of the path restricting member and the inner circumferential surface of the covering portion are brought into contact with each other with a tightening margin. As a result, the path restricting member fitted inside the covering portion is held while being constantly pressed radially inward in the radial direction of the covering portion by the inner surface of the covering portion. For this reason, rattling of the path restricting member can be suppressed inside the covering portion. Also, it is possible to suitably suppress relative movement of the path restricting member with respect to the covering portion in the lengthwise direction of the wire harness body. As a result, in the lengthwise direction of the wire harness body, it is possible to suitably suppress the positional displacement of the path restricting member with respect to the covering portion, and it is possible to suitably suppress the separation of the path restricting member from the covering portion.

[8] It is preferable that when the path restricting member is a first path restricting member, the attachment member is a second path restricting member that is attached to the outer circumferential surface of the exterior member and restricts the path of the wire harness main body, the connection portion is provided at an end portion in a lengthwise direction of the first path restricting member, and the covering portion is provided at an end portion in a lengthwise direction of the second path restricting member.

According to this configuration, the first path restricting member and the second path restricting member are provided so as to partially overlap each other in the lengthwise direction of the wire harness main body. Specifically, in the lengthwise direction of the wire harness body, the connection portion provided at the end in the lengthwise direction of the first path restricting member and the covering portion provided at the end in the lengthwise direction of the second path restricting member are provided so as to overlap each other. For this reason, the first path restricting member and the second path restricting member are connected to each other in the lengthwise direction of the wire harness main body. Accordingly, the path of the wire harness main body can be continuously restricted by the first path restricting member and the second path restricting member.

[9] It is preferable that the first path restricting member restricts a path of a straight section, which is a portion with a linear shape in the path of the wire harness main body, and the second path restricting member restricts a path of a bent section, which is a portion that is bent in the path of the wire harness main body.

According to this configuration, the path of the straight section is restricted by the first path restricting member, and the path of the bent section is restricted by the second path restricting member. As a result, it is possible to prevent the path of the straight section and the path of the bent section from deviating from desired paths.

### Details of Embodiments of the Present Disclosure

A specific example of the wire harness of the present disclosure will be described below with reference to the drawings. In each drawing, some configurations may be exaggerated or simplified for convenience of description. Also, the dimensional ratio of each portion may differ in each drawing. “Orthogonal”, “parallel” and “entire length” in this specification include not only the case of being strictly orthogonal, parallel and the entire length, but also the case of being approximately orthogonal, parallel, and the entire length within a range where the effects in this embodiment are exhibited. In the present specification, the term “equal” includes not only the case of being exactly equal, but also the case where there is a slight difference between objects being compared due to the influence of a dimensional tolerance or the like. In this specification, the term “semicircle” includes not only a semicircle obtained by dividing a perfect circle into two equal halves, but also, for example, an arc longer or shorter than a semicircle. Also, the term “tubular shape” used in the description of this specification includes not only a shape obtained by forming a circumferential wall continuously over the entire circumferential direction, but also a shape in which a plurality of parts are combined to form a tubular shape, and a shape having a notch or the like in a portion in the circumferential direction, like a C shape. Note that “tubular” shapes include, but are not limited to, circles, ovals, and polygons with pointed or rounded corners. Also, the term “ring-shaped” used in the description of this specification may refer to any structure that forms a loop, a continuous shape without ends, as well as a structure that is generally loop-shaped with a gap, such as a C shape. Note that “ring-shaped” shapes include, but are not limited to, circles, ovals, and polygons with pointed or rounded corners. Also, the term “opposing” in this specification refers to surfaces or members being located in front of each other, and includes not only a case where the surfaces or members are located completely in front of each other, but also a case where the surfaces or members are partially located in front of each other. Also, “opposing” in this specification includes both a case where a member different from two portions is interposed between the two portions, and a case where nothing is interposed between the two portions. Note that the present disclosure is not limited to these examples, but is indicated by the scope of the claims, and is intended to include all modifications that fall within the scope and meaning equivalent to the scope of the claims.

### Overall Configuration of Wire Harness 10

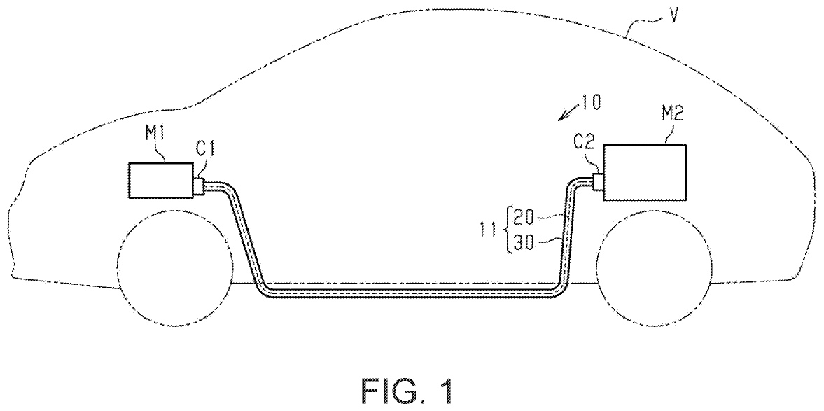

A wire harness 10 shown in FIG. 1 is to be mounted in a vehicle V such as a hybrid vehicle or an electric vehicle, for example. The wire harness 10 electrically connects two or more on-board devices to each other. The on-board devices are electric devices mounted in the vehicle V. The wire harness 10 electrically connects, for example, an inverter M1 that is installed in a front portion of the vehicle V and a high-voltage battery M2 that is installed rearward of the inverter M1 in the vehicle V, to each other. The wire harness 10 is formed in an elongated shape so as to extend in a front-rear direction of the vehicle V, for example. The wire harness 10 is routed in the vehicle V so that, for example, an intermediate portion in the lengthwise direction of the wire harness 10 passes outside the vehicle interior such as under the floor of the vehicle V.

The inverter M1 is, for example, connected to a motor (not shown) for driving wheels, which serves as a power source when the vehicle travels. The inverter M1 generates AC power from the DC power of the high-voltage battery M2, and supplies the AC power to the motor. The high-voltage battery M2 is, for example, a battery that is capable of supplying a voltage of several hundred volts.

The wire harness 10 includes a wire harness main body 11. The wire harness main body 11 includes an electric wire member 20 and a tubular exterior member 30 (exterior tube) that encloses the outer circumferential surface of the electric wire member 20 (electric wire). The wire harness 10 has connectors C1 and C2 that are respectively attached to two end portions of the electric wire member 20. One end portion in the lengthwise direction of the electric wire member 20 is connected to the inverter M1 via the connector C1, and the other end portion in the lengthwise direction of the electric wire member 20 is connected to the high-voltage battery M2 via the connector C2.

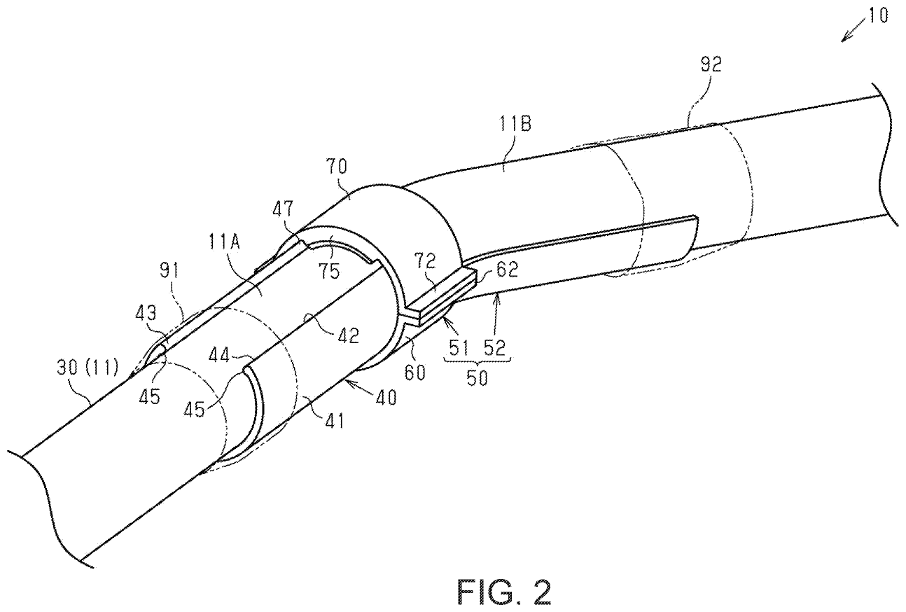

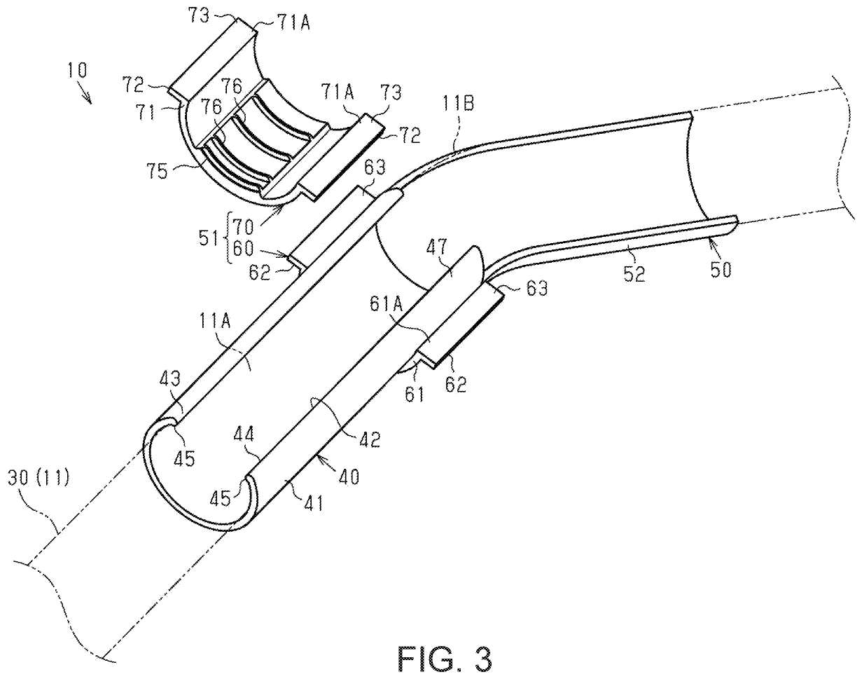

As shown in FIGS. 2 and 3, the wire harness 10 includes a first path restricting member 40 (first path restrictor) that is attached to the outer circumferential surface of the exterior member 30 and a second path restricting member 50 (second path restrictor) that is attached to the outer circumferential surface of the exterior member 30. The first path restricting member 40 and the second path restricting member 50 restrict the path along which the wire harness main body 11 is routed. Note that the first path restricting member 40 and the second path restricting member 50 are omitted from FIG. 1.

### Configuration of Electric Wire Member 20

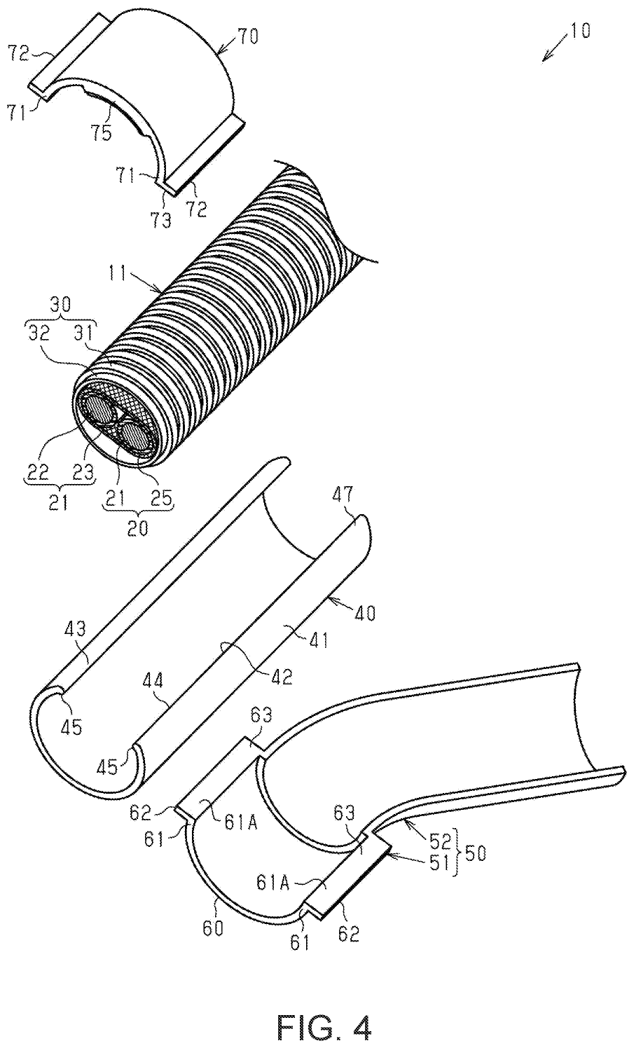

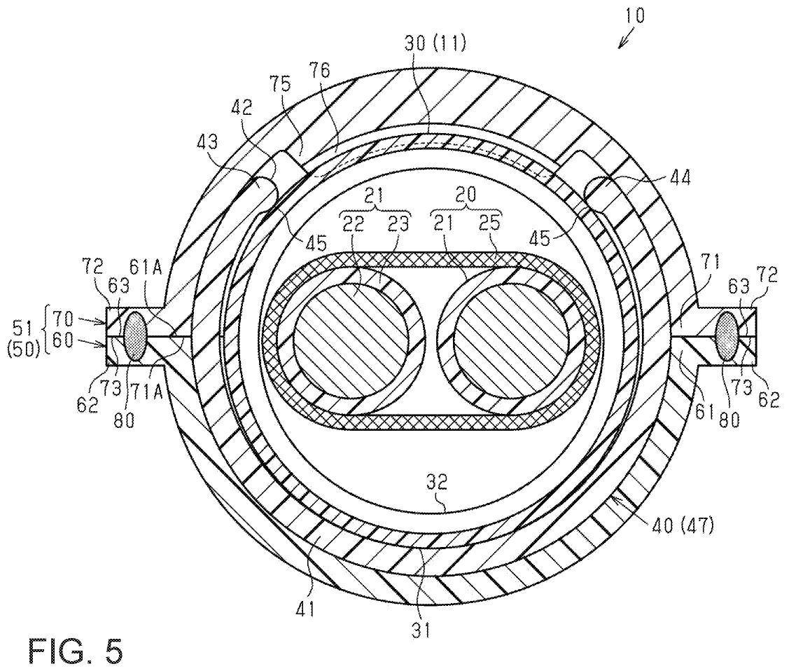

As shown in FIGS. 4 and 5, for example, the electric wire member 20 includes one or more electric wires 21 (two in the present embodiment) and a braided member 25 that collectively encloses the outer circumferential surfaces of the plurality of electric wires 21.

As shown in FIG. 5, each electric wire 21 is a coated electric wire that includes a conductive core wire 22 and an insulating coating 23 that encloses the outer circumferential surface of the core wire 22 and has insulating properties. Each electric wire 21 is, for example, a high-voltage electric wire that withstands a high voltage and a large current. Each electric wire 21 may be, for example, a non-shielded electric wire that does not have an electromagnetic shield structure, or a shielded electric wire that has an electromagnetic shield structure. Each electric wire 21 in the present embodiment is a non-shielded electric wire.

As the core wire 22, a stranded wire that is constituted by a plurality of metal strands twisted together, a single core wire that is constituted by a single conductor, or the like may be used, for example. As the single core wire, a columnar conductor that is constituted by one columnar metal rod with a solid internal structure, a tubular conductor with a hollow internal structure, or the like may be used, for example. As the core wire 22, a combination of a stranded wire, a columnar conductor, or a tubular conductor may be used. As the material of the core wire 22, a metal material such as a copper-based material or an aluminum-based material may be used, for example.

The insulating coating 23 covers, for example, the entirety of the outer circumferential surface of the core wire 22 in the circumferential direction. The insulating coating 23 is constituted by, for example, a resin material that has insulating properties.

The cross-sectional shape of each wire 21 cut along a plane that is orthogonal to the lengthwise direction of each wire 21, that is, the transverse cross-sectional shape of each wire 21, may be any shape. The transverse cross-sectional shape of each electric wire 21 may be, for example, a circular shape, a semicircular shape, a polygonal shape, a square shape, a flat shape, or the like. The transverse cross-sectional shape of each electric wire 21 in the present embodiment is a circular shape.

The braided member 25 has, for example, a tubular shape that collectively encloses the outer circumferential surfaces of the plurality of electric wires 21. As the braided member 25, a braided wire in which a plurality of metal strands are braided or a braided wire in which metal strands and resin strands are braided in combination with each other may be used, for example. As the material of the metal strands, a metal material such as a copper-based material or an aluminum-based material may be used, for example. Although not shown in the drawings, the two end portions of the braided member 25 in the lengthwise direction are grounded at, for example, the connectors C1 and C2 (see FIG. 1).

### Configuration of Exterior Member 30

As shown in FIG. 4, the exterior member 30 has a tubular shape that encloses the entirety of the outer circumferential surface of the electric wire member 20 in the circumferential direction. The exterior member 30 in the present embodiment is formed in a cylindrical shape. The exterior member 30 is, for example, provided with a circumferential wall that is formed so as to be continuous over the entire circumferential direction of the exterior member 30. The exterior member 30 is, for example, sealed over the entire circumferential direction of the exterior member 30. The exterior member 30 has, for example, a function of protecting the electric wire member 20 from flying objects and water droplets.

The exterior member 30 has, for example, flexibility and is easily bendable. Examples of the flexible exterior member 30 include a resin corrugated tube and a rubber waterproof cover. The exterior member 30 of the present embodiment is a resin corrugated tube having an accordion structure in which ring-shaped protrusions 31 and ring-shaped recesses 32 are provided alternatingly and continuously along the lengthwise direction of the exterior member 30. Each of the ring-shaped protrusions 31 and the ring-shaped recesses 32 has, for example, a ring shape that encircles the exterior member 30 in the circumferential direction. As the material of the exterior member 30, for example, a synthetic resin such as polyolefin, polyamide, polyester, or ABS resin can be used. Note that in FIGS. 1 to 3, the exterior member 30 is shown simplified.

### Configuration of First Path Restricting Member 40 and Second Path Restricting Member 50

As shown in FIG. 2, each of the first path restricting member 40 and the second path restricting member 50 holds the exterior member 30. Each of the first path restricting member 40 and the second path restricting member 50 is harder than, for example, the exterior member 30. Each of the first path restricting member 40 and the second path restricting member 50 has a hardness that makes it more difficult to bend in a direction orthogonal to the lengthwise direction of the wire harness main body 11 compared to the exterior member 30. As a result, each of the first path restricting member 40 and the second path restricting member 50 restricts the path of the wire harness main body 11. For example, each of the first path restricting member 40 and the second path restricting member 50 assists the exterior member 30 so that the wire harness main body 11 does not deviate from the desired path by bending due to its own weight or the like. The exterior member 30 is more difficult to bend than, for example, in a state where the first path restricting member 40 and the second path restricting member 50 are not attached.

The first path restricting member 40 is partially provided in the lengthwise direction of the wire harness main body 11. For example, the first path restricting member 40 is attached to the outer circumferential surface of the exterior member 30 along a straight section 11A, which is a straight section of the path of the wire harness main body 11. The first path restricting member 40 restricts the path of the wire harness main body 11 in the straight section 11A. Here, the straight section 11A is a section in which the path of the wire harness main body 11 extends straight in one direction. Note that one or more first path restricting members 40 are provided depending on the path of the wire harness main body 11.

The second path restricting member 50 is provided along a portion in the lengthwise direction of the wire harness main body 11. For example, the second path restricting member 50 is attached to the outer circumferential surface of the exterior member 30 along a bent section 11B, which is a bent section of the path of the wire harness main body 11. The second path restricting member 50 restricts the path of the wire harness main body 11 in the bent section 11B. Here, the bent section 11B is a section in which the path of the wire harness main body 11 is bent two-dimensionally or three-dimensionally. Note that one or more second path restricting members 50 may be provided depending on the path of the wire harness main body 11.

### Configuration of First Path Restricting Member 40

As shown in FIG. 5, the first path restricting member 40 covers part of the outer circumferential surface of the exterior member 30 in the circumferential direction of the exterior member 30. The first path restricting member 40 has a tubular shape that covers the outer circumferential surface of the exterior member 30 in a portion in the circumferential direction of the exterior member 30. The transverse cross-sectional shape of the first path restricting member 40 is C-shaped overall. The first path restricting member 40 covers, for example, a range larger than half of the outer circumferential surface of the exterior member 30. That is, the first path restricting member 40 covers a region of the outer circumferential surface of the exterior member 30 that is larger than half of the entire circumferential direction of the exterior member 30. The transverse cross-sectional shape of the first path restricting member 40 is, for example, uniform over the entire length in the lengthwise direction of the first path restricting member 40. As shown in FIG. 2, the first path restricting member 40 extends along the path of the straight section 11A, and is formed in a shape extending linearly in one direction, for example.

The first path restricting member 40 is made of metal or resin, for example. The first path restricting member 40 of this embodiment is made of resin. Synthetic resins such as polypropylene, polyamide, and polyacetal can be used as the material of the first path restricting member 40, for example. The first path restricting member 40 can be manufactured through a known manufacturing method such as extrusion molding or injection molding. In this embodiment, the first path restricting member 40 is an extrusion molded product manufactured through extrusion molding. For this reason, the first path restricting member 40 can be easily manufactured by using an extrusion molder that extrudes the raw material of the first path restricting member 40 in the lengthwise direction. Also, a single extrusion molder can be used to manufacture a plurality of types of first path restricting members 40 having different dimensions in the lengthwise direction. For example, by cutting the base material of the first path restricting member 40 formed by a single extrusion molder to an appropriate length using a cutting machine, a plurality of types of first path restricting members 40 having different dimensions in the lengthwise direction can be manufactured.

As shown in FIG. 5, the first path restricting member 40 has a main body portion 41 (main body) that covers part of the outer circumferential surface of the exterior member 30, and an insertion port 42 that opens in a direction orthogonal to the lengthwise direction of the main body portion 41. The first path restricting member 40 has a first end portion 43 and a second end portion 44 which are both ends in the circumferential direction of the main body portion 41 and form an insertion port 42.

The main body portion 41 forms the main part of the first path restricting member 40. The thickness in the radial direction of the main body portion 41 is, for example, uniform in the circumferential direction of the first path restricting member 40. The transverse cross-sectional shape of the main body portion 41 is formed, for example, in a shape that extends along the outer surface of the exterior member 30. The transverse cross-sectional shape of the main body portion 41 is formed, for example, in an arc shape.

The first end portion 43 and the second end portion 44 are provided on mutually opposite sides in the circumferential direction of the main body portion 41. The first end portion 43 and the second end portion 44 are provided spaced apart from each other with the insertion port 42 interposed therebetween in the circumferential direction of the main body portion 41. In other words, the gap between the first end portion 43 and the second end portion 44 in the circumferential direction of the first path restricting member 40 is formed as the insertion port 42. As described above, the first path restricting member 40 is formed in a C shape having the insertion port 42 in a portion in the circumferential direction of the main body portion 41.

The opening width of the insertion slot 42, that is, the shortest distance between the first end portion 43 and the second end portion 44 is smaller than, for example, the outer diameter of the exterior member 30. As shown in FIG. 4, the insertion port 42 extends along the lengthwise direction of the main body portion 41 over the entire length in the lengthwise direction of the main body portion 41. That is, the insertion port 42 is formed so as to be open in a direction orthogonal to the lengthwise direction of the main body portion 41 and to be open at both ends in the lengthwise direction of the main body portion 41.

By inserting the exterior member 30 into the insertion port 42 from a direction orthogonal to the lengthwise direction of the first path restricting member 40, the first path restricting member 40 is elastically deformed and the opening width of the insertion port 42 is increased. When the exterior member 30 is inserted into the first path restricting member 40, the first path restricting member 40 elastically returns to its original shape. As a result, the opening width of the insertion port 42 is smaller than the outer diameter of the exterior member 30, and therefore the first path restricting member 40 is attached to the outer circumferential surface of the exterior member 30.

Note that when the exterior member 30 is inserted into the first path restricting member 40, the opening width of the insertion port 42 does not necessarily return to its original width, that is, the width when the exterior member 30 has not been inserted. More specifically, the exterior member 30 obstructs the elastic deformation of the main body 41 to return to its original shape, and thereby the opening width of the insertion port 42 becomes slightly larger than the original width in some cases. Also, while the exterior member 30 is inserted into the first path restricting member 40, the exterior member 30 is bent due to the pressure of the first path restricting member 40, and thereby the opening width of the insertion port 42 returns to the original width in some cases. That is, the opening width of the insertion port 42 in the state where the exterior member 30 is inserted in the first path restricting member 40 is determined based on the rigidity and ease of bending of the exterior member 30 and the first path restricting member 40. In the first path restricting member 40 of the present embodiment, the opening width of the insertion port 42 is slightly larger than the original width when the exterior member 30 is inserted therein. When the exterior member 30 is inserted in the first path restricting member 40, the outer diameter of the first path restricting member 40 of the present embodiment is larger by the protrusion amount of a protruding portion 45 compared to the outer diameter when the exterior member 30 has not been inserted therein.

As shown in FIG. 5, the first path restricting member 40 has, for example, protruding portions 45 protruding from the inner surfaces of the first end portion 43 and the second end portion 44. Each protruding portion 45 protrudes toward the exterior member 30 inserted into the first path restricting member 40 and can come into contact with the outer surface of the exterior member 30. The protruding portions 45 are in contact with, for example, the outer surfaces of the ring-shaped protrusions 31 of the exterior member 30. The transverse cross-sectional shape of each protruding portion 45 is formed, for example, into a curved shape. The transverse cross-sectional shape of each protruding portion 45 of the present embodiment is formed in a semicircular shape. Each protruding portion 45 extends, for example, along the lengthwise direction of the first path restricting member 40 over the entire length in the lengthwise direction of the first path restricting member 40.

Each protruding portion 45 presses the exterior member 30 from the outside of the exterior member 30, for example. The exterior member 30 is elastically sandwiched by the two protruding portions 45 and the main body portion 41. As a result, the connection of the first path restricting member 40 to the exterior member 30 is strengthened. Accordingly, the first path restricting member 40 attached to the outer circumferential surface of the exterior member 30 is suppressed from moving in the lengthwise direction of the exterior member 30.

As shown in FIGS. 2 and 3, the first path restricting member 40 has a connecting portion 47 (connection) that is to be connected to the second path restricting member 50. The connecting portion 47 is provided, for example, at one end portion in the lengthwise direction of the first path restricting member 40.

### Configuration of Second Path Restricting Member 50

As shown in FIG. 2, the second path restricting member 50 is attached to the outer circumferential surface of the exterior member 30 at the bent section 11B. The second path restricting member 50 is bent, for example, along the shape of the bent section 11B.

The second path restricting member 50 has a covering portion 51 (cover) that covers a part of the first path restricting member 40 in the lengthwise direction, and a path restricting portion 52 to be attached to the outer circumferential surface of the exterior member 30. In the second path restricting member 50, for example, the covering portion 51 and the path restricting portion 52 are formed continuously in the lengthwise direction of the wire harness body 11. The covering portion 51 is provided, for example, at one end of the second path restricting member 50 in the lengthwise direction. The covering portion 51 includes a receiving portion 60 (receiver), a lid portion 70 (lid), and a joining portion 80 (joint) (see FIG. 5) where the receiving portion 60 and the lid portion 70 are joined. The lid portion 70 is, for example, a component separate from the receiving portion 60. The path restricting portion 52 is formed in one piece continuously with the receiving portion 60. That is, the receiving portion 60 and the path restricting portion 52 are a single component.

The receiving portion 60, the lid portion 70, and the path restricting portion 52, which constitute the second path restricting member 50, are made of metal or resin, for example. The receiving portion 60, the lid portion 70, and the path restricting portion 52 of this embodiment are made of resin. As materials for the receiving portion 60, the lid portion 70, and the path restricting portion 52, for example, synthetic resins such as polypropylene, polyamide, and polyacetal can be used. The second path restricting member 50 can be manufactured, for example, through a known manufacturing method such as injection molding.

### Configuration of Path Restricting Portion 52

The path restricting portion 52 extends, for example, along the path of the bent section 11B. That is, the path restricting portion 52 has a bent shape that follows the shape of the bent section 11B. The path restricting portion 52 covers, for example, part of the outer circumferential surface of the exterior member 30 in the circumferential direction of the exterior member 30. The path restricting portion 52 has a tubular shape that covers the outer circumferential surface of the exterior member 30 at a portion of the exterior member 30 in the circumferential direction. The path restricting portion 52 is, for example, formed in a semi-cylindrical shape overall. The path restricting portion 52 covers half of the outer circumferential surface of the exterior member 30, for example.

### Configuration of Covering Portion 51

As shown in FIG. 3, the covering portion 51 is provided, for example, so as to overlap with the connecting portion 47 in the radial direction of the exterior member 30. That is, in the wire harness 10, one end portion in the lengthwise direction of the first path restricting member 40 and one end portion in the lengthwise direction of the second path restricting member 50 are provided so as to overlap with each other in the lengthwise direction of the wire harness main body 11.

The covering portion 51 encloses, for example, the outer circumferential surface of the connecting portion 47 of the first path restricting member 40. The covering portion 51 is formed, for example, in a ring shape that encloses, in the circumferential direction, the entirety of the outer circumferential surface of the connecting portion 47 and the exterior member 30 at the portion to which the connecting portion 47 is attached. The covering portion 51 extends, for example, along the path of the straight section 11A, and is formed in a shape extending linearly in one direction.

As shown in FIG. 5, the receiving portion 60 covers, for example, part of the outer circumferential surface of the exterior member 30 in the circumferential direction of the exterior member 30. The receiving portion 60 covers, for example, part of the outer circumferential surface of the first path restricting member 40 in the circumferential direction of the first path restricting member 40. The receiving portion 60 covers a portion in the circumferential direction of the connecting portion 47 of the first path restricting member 40. The receiving portion 60 covers the outer circumferential surface of the main body portion 41 of the connecting portion 47. The receiving portion 60 has a tubular shape that covers the outer circumferential surface of the first path restricting member 40 at a portion of the first path restricting member 40 in the circumferential direction. The receiving portion 60 covers half of the outer circumferential surface of the first path restricting member 40. The receiving portion 60 is, for example, formed in a semi-cylindrical shape overall. As shown in FIG. 4, the receiving portion 60 is formed, for example, in a semi-cylindrical shape with an inner diameter larger than that of the path restricting portion 52. The transverse cross-sectional shape of the inner surface of the receiving portion 60 is formed in a shape extending along the outer surface of the main body portion 41. The transverse cross-sectional shape of the inner surface of the receiving portion 60 is formed in a semicircular arc shape.

As shown in FIG. 5, the receiving portion 60 has two end portions 61 that are the two ends of the receiving portion 60 in the circumferential direction. Each end portion 61 has an end surface 61A in the circumferential direction of the receiving portion 60. The receiving portion 60 has a first fixing portion 62 (first protrusion), for example. The receiving portion 60 of this embodiment has two first fixing portions 62. The two first fixing portions 62 are provided, for example, at the two end portions 61, respectively. Each first fixing portion 62 protrudes outward in the radial direction of the covering portion 51 from each end portion 61. The two first fixing portions 62 protrude in the radial direction of the covering portion 51 in opposite directions to each other. Each first fixing portion 62 protrudes in a direction away from the inner space of the covering portion 51. Each first fixing portion 62 is provided, for example, so as not to overlap with the insertion port 42 of the first path restricting member 40 accommodated inside of the covering portion 51 in the radial direction of the covering portion 51. As shown in FIGS. 3 and 4, each first fixing portion 62 extends along the lengthwise direction of the covering portion 51, for example. Each first fixing portion 62 extends over the entire length in the lengthwise direction of the covering portion 51, for example. Each first fixing portion 62 has a first matching surface 63 extending along the radial direction of the covering portion 51. The first matching surface 63 is a plane continuous with the end surface 61A in the circumferential direction of the receiving portion 60. The first matching surface 63 extends over the entire length in the lengthwise direction of the covering portion 51 along the lengthwise direction of the covering portion 51, for example.

As shown in FIG. 5, the lid portion 70 covers the entire circumference of the first path restricting member 40 together with the receiving portion 60. Specifically, together with the receiving portion 60, the lid portion 70 covers the entirety of the outer circumferential surface of the connecting portion 47 of the first path restricting member 40 in the circumferential direction. The lid portion 70 of the present embodiment covers a portion of the outer circumferential surface of the main body portion 41 of the connecting portion 47 and a portion of the outer circumferential surface of the exterior member 30 exposed from the insertion port 42. The lid portion 70 has a tubular shape that covers the outer circumferential surface of the first path restricting member 40 at a portion of the first path restricting member 40 in the circumferential direction. The lid portion 70 covers half of the outer circumferential surface of the first path restricting member 40. The lid portion 70 covers a portion of the outer circumferential surface of the first path restricting member 40 that is not covered by the receiving portion 60, and is half of the outer circumferential surface of the first path restricting member 40 in the circumferential direction. The lid portion 70 is, for example, formed in a semi-cylindrical shape overall. The lid portion 70 is formed in a semi-cylindrical shape having the same inner diameter as the receiving portion 60, for example. The lid portion 70 is formed in a semi-cylindrical shape having the same outer diameter as the receiving portion 60, for example. The transverse cross-sectional shape of the inner surface of the lid portion 70 is, for example, formed in a shape extending along the outer surface of the first path restricting member 40. The transverse cross-sectional shape of the inner surface of the lid portion 70 is formed in a semicircular arc shape.

The lid portion 70 has two end portions 71 that are the two end portions of the lid portion 70 in the circumferential direction. Each end portion 71 has an end surface 71A in the circumferential direction of the lid portion 70. The lid portion 70 has a second fixing portion 72 (second protrusion), for example. The lid portion 70 of this embodiment has two second fixing portions 72. The two second fixing portions 72 are provided, for example, at the two end portions 71 respectively. The second fixing portions 72 are provided so as to overlap with the first fixing portions 62. Each second fixing portion 72 protrudes outward in the radial direction of the covering portion 51 from each end portion 71. The two second fixing portions 72 protrude in the radial direction of the covering portion 51 in opposite directions to each other. Each second fixing portion 72 protrudes in a direction away from the inner space of the covering portion 51. Each second fixing portion 72 is provided, for example, so as not to overlap with the insertion port 42 of the first path restricting member 40 accommodated inside the covering portion 51, in the radial direction of the covering portion 51. As shown in FIG. 3, each second fixing portion 72 extends along the lengthwise direction of the covering portion 51, for example. Each second fixing portion 72 extends over the entire length in the lengthwise direction of the covering portion 51, for example. The second fixing portions 72 have the same shape as the first fixing portions 62, for example. Each second fixing portion 72 has a second matching surface 73 extending along the radial direction of the covering portion 51. The second matching surface 73 is a flat surface that is continuous with the end surface 71A in the circumferential direction of the lid portion 70. As shown in FIG. 5, the second matching surfaces 73 are provided facing the first matching surfaces 63. The second matching surfaces 73 are provided so as to be in contact with the first matching surfaces 63 while being overlaid on the first matching surfaces 63.

The receiving portion 60 and the lid portion 70 are united so that the end portions 61 on both sides in the circumferential direction of the receiving portion 60 and the end portions 71 on both sides in the circumferential direction of the lid portion 70 are overlapped with each other. The receiving portion 60 and the lid portion 70 are united so that, for example, the first matching surface 63 and the second matching surface 73 are overlapped with each other while the first fixing portion 62 and the second fixing portion 72 are overlapped with each other. The first fixing portion 62 overlaps with the second fixing portion 72 in a direction (vertical direction in the drawing) orthogonal to the protruding direction of the first fixing portion 62 (left-right direction in the drawing). The receiving portion 60 and the lid portion 70 are united by, for example, joining the first fixing portion 62 and the second fixing portion 72 together. At the joining portion 80 where the first fixing portion 62 and the second fixing portion 72 are joined together, for example, the first fixing portion 62 and the second fixing portion 72 that are overlapped with each other are joined together by welding. That is, the joining portion 80 is, for example, a welded portion where the first fixing portion 62 and the second fixing portion 72 are welded together. As the welding method, a known welding method such as laser welding, arc welding, gas welding, and spot welding can be employed. In the joining portion 80 of the present embodiment, the first fixing portion 62 and the second fixing portion 72 that are overlapped with each other are joined together by spot welding. Note that the method of joining the first fixing portion 62 and the second fixing portion 72 together is not limited to welding, and joining using an adhesive or the like, for example, can also be adopted.

The joining portion 80 of the present embodiment is provided only on the first fixing portion 62 and the second fixing portion 72 of the receiving portion 60 and the lid portion 70. That is, the joining portion 80 of the present embodiment is not provided at the end portions 61 on both sides in the circumferential direction of the receiving portion 60 and the end portions 71 on both sides in the circumferential direction of the lid portion 70. The joining portion 80 is provided, for example, so as not to overlap the insertion port 42 of the first path restricting member 40 in the radial direction of the covering portion 51. The joining portion 80 is provided, for example, so as to overlap with the main body portion 41 of the first path restricting member 40 in the radial direction of the covering portion 51. The joining portion 80 is formed over the entire length in the lengthwise direction of the covering portion 51, for example. By this joining portion 80, the receiving portion 60 and the lid portion 70 are non-removably fixed to each other, and the fixed state of the receiving portion 60 and the lid portion 70 is maintained. In a state in which the receiving portion 60 and the lid portion 70 are fixed by the joining portion 80, the covering portion 51 has a ring shape surrounding the outer circumferential surface of the exterior member 30 and the connecting portion 47 together. That is, in the covering portion 51, the joining portion 80 holds the receiving portion 60 and the lid portion 70 in a ring shape. In this ring state, the receiving portion 60 and the lid portion 70 are set so as to cover the entirety of the outer circumferential surface of the exterior member 30 and the first path restricting member 40 in the circumferential direction, and sandwich the first path restricting member 40 therebetween. Also, the inner surface of the covering portion 51 in the ring state is in areal contact with the outer surface of the first path restricting member 40, for example. The inner surface of the covering portion 51 in the ring state presses the outer surface of the first path restricting member 40 inward in the radial direction of the covering portion 51, for example.

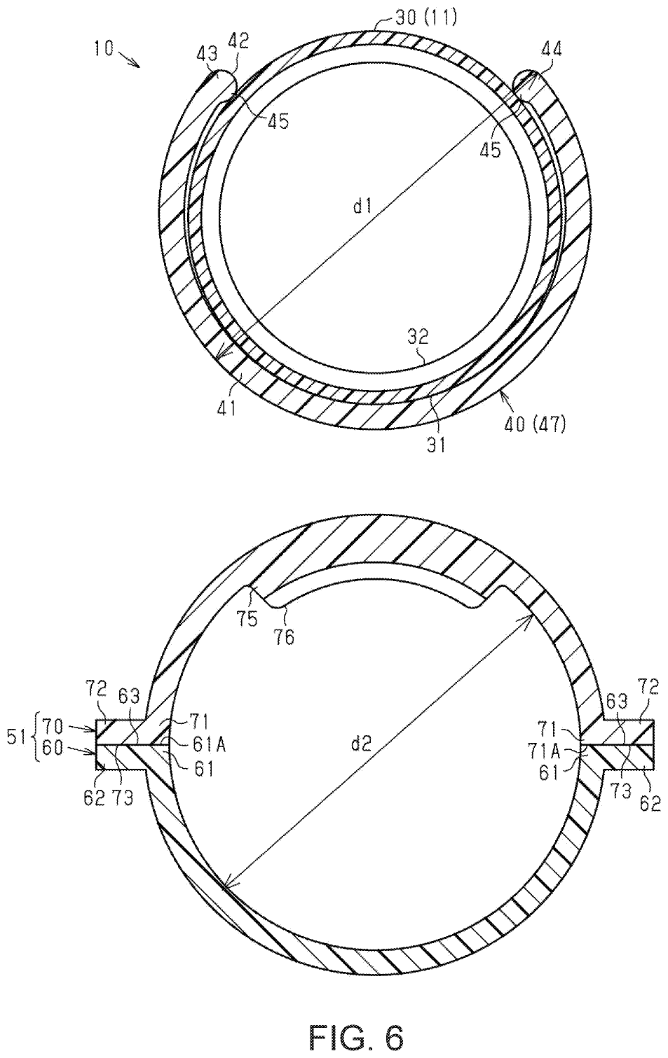

As shown in FIG. 6, a fastening margin is provided, for example, between the inner circumferential surface of the covering portion 51 and the outer circumferential surface of the first path restricting member 40. For example, a minimum inner diameter d2 of the covering portion 51 is set smaller than a maximum outer diameter d1 of the first path restricting member 40 when attached to the outer circumferential surface of the exterior member 30 and before being inserted into the covering portion 51. Here, in the first path restricting member 40 of the present embodiment, when the exterior member 30 is inserted therein, the opening width of the insertion port 42 is slightly larger than the original width, that is, the width when the exterior member 30 is not inserted. Specifically, when the exterior member 30 is inserted in the first path restricting member 40, the outer diameter of the first path restricting member 40 of the present embodiment is larger by the protrusion amount of the protruding portion 45 compared to the outer diameter when the exterior member 30 is not inserted. For this reason, the maximum outer diameter d1 of the present embodiment is the outer diameter of the portion passing through the protruding portion 45 in the first path restricting member 40 when attached to the outer circumferential surface of the exterior member 30 and before being inserted into the covering portion 51. Also, the minimum inner diameter d2 of this embodiment is the inner diameter of the covering portion 51 at the position corresponding to the maximum outer diameter d1. The minimum inner diameter d2 is, for example, set smaller than the maximum outer diameter d1 by the protruding amount of the protruding portion 45.

By setting the maximum outer diameter d1 and the minimum inner diameter d2 in this manner, the first path restricting member 40 attached to the outer circumferential surface of the exterior member 30 is fitted to the inner circumferential surface of the covering portion 51 with a tightening margin. As shown in FIG. 5, when the receiving portion 60 and the lid portion 70 are held in a ring state while the exterior member 30 and the first path restricting member 40 are accommodated inside the covering portion 51, the first path restricting member 40 is fitted in and fixed to the inner circumferential surface of the covering portion 51 with a tightening margin. As a result, the inner circumferential surface of the covering portion 51 and the outer circumferential surface of the first path restricting member 40 come into contact with each other with a tightening margin. That is, the first path restricting member 40 fitted inside the covering portion 51 is held in a state of being constantly pressed inward in the radial direction of the covering portion 51 by the inner surface of the covering portion 51. For this reason, rattling of the first path restricting member 40 inside the covering portion 51 can be suppressed.

The covering portion 51 has, for example, a projecting portion 75. The projecting portion 75 protrudes from the inner surface of the covering portion 51 toward the insertion port 42 of the first path restricting member 40 inserted in the covering portion 51. The projecting portion 75 protrudes so as to be arranged inside the insertion port 42. The projecting portion 75 can come into contact with the first end portion 43 and the second end portion 44 in the circumferential direction of the first path restricting member 40. Due to the projecting portion 75 and the first end portion 43 or the second end portion 44 being engaged with each other, relative movement of the first path restricting member 40 with respect to the covering portion 51 in the circumferential direction of the first path restricting member 40 is suppressed. For this reason, it is possible to suppress misalignment of the first path restricting member 40 with respect to the covering portion 51 in the circumferential direction of the first path restricting member 40.

The projecting portion 75 is provided on the inner surface of the lid portion 70, for example. The projecting portion 75 protrudes from the inner surface of the lid portion 70 toward the receiving portion 60, for example. For this reason, when the projecting portion 75 is arranged inside the insertion port 42, the insertion port 42 faces the lid portion 70 side of the covering portion 51.

As shown in FIG. 3, the projecting portion 75 extends along the lengthwise direction of the wire harness main body 11, for example. The projecting portion 75 extends over the entire length of the covering portion 51 along the lengthwise direction of the covering portion 51, for example. The projecting portion 75 is provided partially in the circumferential direction of the lid portion 70, for example. The projecting portion 75 is provided, for example, at an intermediate portion in the circumferential direction of the lid portion 70.

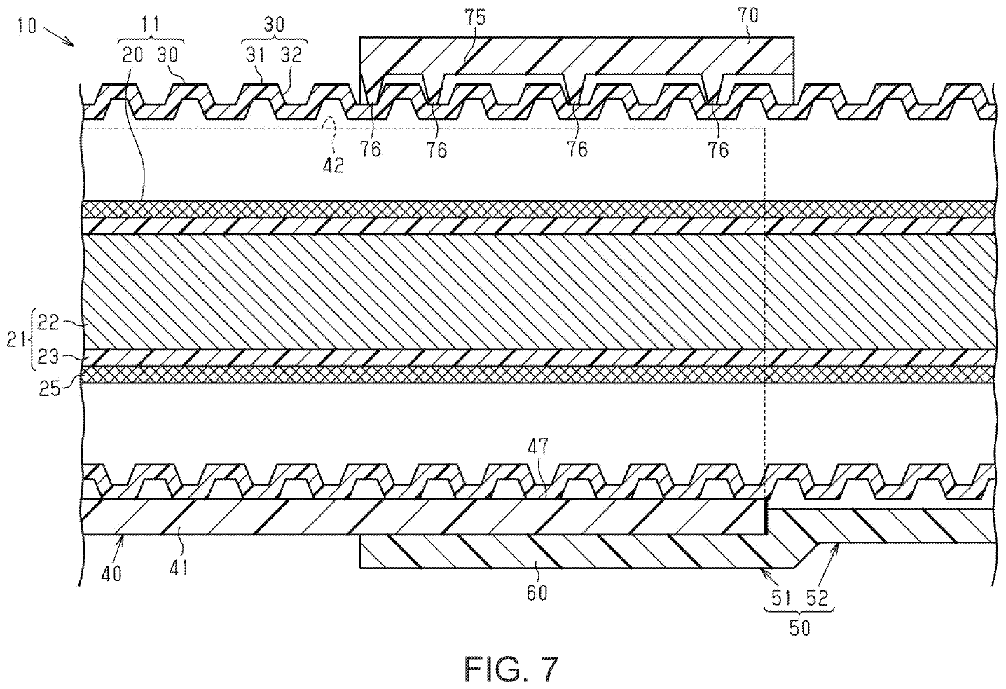

As shown in FIG. 7, the projecting portion 75 has, for example, a protrusion 76 that fits into a ring-shaped recess 32 of the exterior member 30. The protrusion 76 is provided so as to further protrude from the projecting leading end surface of the projecting portion 75. A plurality of protrusions 76 are provided in the lengthwise direction of the wire harness main body 11. In this embodiment, four protrusions 76 are provided in the lengthwise direction of the wire harness main body 11, and each of the protrusions 76 is inserted into a different ring-shaped recess 32. Due to the protrusions 76 entering the ring-shaped recesses 32, movement of the exterior member 30 relative to the second path restricting member 50 in the lengthwise direction of the exterior member 30 can be suppressed.

### Configuration of Restricting Members 91 and 92

As shown in FIG. 2, the wire harness 10 has a restricting member 91 that restricts movement of the first path restricting member 40 with respect to the exterior member 30, for example. The wire harness 10 has, for example, a restricting member 92 that restricts movement of the second path restricting member 50 with respect to the exterior member 30. As the restricting members 91 and 92, for example, a cable tie made of resin or metal, a crimping ring, adhesive tape, or the like can be used. The restricting members 91 and 92 of this embodiment are adhesive tape.

The restricting member 91 is formed, for example, so as to fix the end portion provided on the side opposite to the connecting portion 47 out of the end portions in the lengthwise direction of the first path restricting member 40 to the outer surface of the exterior member 30. The restricting member 91 is wound, for example, from the outer surface of the end portion in the lengthwise direction of the first path restricting member 40 to the outer surface of the exterior member 30. Accordingly, it is possible to suppress movement of the first path restricting member 40 with respect to the exterior member 30 in the lengthwise direction and the circumferential direction of the wire harness body 11. The restricting member 92 is formed, for example, so as to fix the end portion provided on the side opposite to the covering portion 51 out of the end portions in the lengthwise direction of the second path restricting member 50 to the outer surface of the exterior member 30. The restricting member 92 is wound, for example, from the outer surface of the end portion in the lengthwise direction of the second path restricting member 50 to the outer surface of the exterior member 30. This makes it possible to suppress movement of the second path restricting member 50 with respect to the exterior member 30 in the lengthwise direction and the circumferential direction of the wire harness body 11.

Next, actions of this embodiment will be described.

In the lengthwise direction of the wire harness main body 11, the connecting portion 47 of the first path restricting member 40 and the covering portion 51 of the second path restricting member 50 are provided so as to overlap each other. At this time, the outer circumferential surface of the first path restricting member 40 is covered with the receiving portion 60 and the lid portion 70 in the covering portion 51, and the receiving portion 60 and the lid portion 70 are joined together. By joining the receiving portion 60 and the lid portion 70 together, the receiving portion 60 and the lid portion 70 are maintained in a state in which the first path restricting member 40 is sandwiched therebetween. As a result, the state in which the first path restricting member 40 and the second path restricting member 50 are connected is maintained. As a result, the path of the wire harness body 11 is continuously restricted by the first path restricting member 40 and the second path restricting member 50.

Next, the effects of this embodiment will be described.

(1) The covering portion 51 includes a receiving portion 60 that covers a portion of the first path restricting member 40 in the circumferential direction, and a lid portion 70 that covers the entirety of the outer circumferential surface of the first path restricting member 40 together with the receiving portion 60, in the circumferential direction. The receiving portion 60 and the lid portion 70 are joined to each other at the joining portion 80. By doing so, for example, rattling between the receiving portion 60 and the lid portion 70 is suppressed compared to a configuration where the lid portion 70 is formed in one piece with the receiving portion 60 via the thin hinge portion and the lid portion 70 is locked to the receiving portion 60 through engagement of the claw portion in the closed state. That is, in a configuration having a thin hinge portion and claw portion, the receiving portion 60 and the lid portion 70 are likely to rattle at each portion of the hinge portion and the claw portion, and in a configuration where the receiving portion 60 and the lid portion 70 are joined together, it is possible to suppress the occurrence of such rattling. Accordingly, the first path restricting member 40 can be sandwiched between the receiving portion 60 and the lid portion 70 without rattling, and rattling between the first path restricting member 40 and the second path restricting member 50 can be suppressed. As a result, for example, it is possible to suppress damage to the attachment portions of the first path restricting member 40 and the second path restricting member 50, and consequently, the path of the wire harness body 11 can be stably restricted.

(2) The covering portion 51 is formed in a ring shape in which the receiving portion 60 and the lid portion 70 collectively surround the connecting portion 47 and the exterior member 30. According to this configuration, although the covering portion 51 is formed in a ring shape surrounding the connecting portion 47 and the exterior member 30, due the covering portion 51 being divided into the receiving portion 60 and the lid portion 70, the second path restricting member 50 including the covering portion 51 can be retrofitted to the first path restricting member 40 and the exterior member 30. This makes it possible to improve the assembly workability of the wire harness 10.

(3) The insertion port 42 of the first path restricting member 40 is open in a direction orthogonal to the lengthwise direction of the main body portion 41 and extends over the entire length in the lengthwise direction of the main body portion 41. This makes it possible to attach the first path restricting member 40 from the insertion port 42 to the exterior member 30 after performing terminal processing such as attaching connectors C1 and C2 to the end portions in the lengthwise direction of the electric wire members 20. In this manner, since the first path restricting member 40 can be retrofitted, it is possible to improve the assembly workability of the wire harness 10.

(4) The receiving portion 60 and the lid portion 70 are joined together through welding. For this reason, the receiving portion 60 and the lid portion 70 can be joined together without interposing another member such as an adhesive between the receiving portion 60 and the lid portion 70. Accordingly, an increase in the number of parts in the covering portion 51 can be suppressed.

(5) The first fixing portion 62 that protrudes radially outward from the end portion 61 in the circumferential direction of the receiving portion 60 is provided, and the second fixing portion 72 that protrudes radially outward from the end portion 71 in the circumferential direction of the lid portion 70 and overlaps with the first fixing portion 62 is provided. Then, the first fixing portion 62 and the second fixing portion 72 are joined together by being welded. This makes it possible to provide the joining portion 80, that is, the welded portion, at a position away from the inner space of the covering portion 51. For this reason, the welded portion can be provided at a position away from the electric wire member 20 accommodated in the inner space of the covering portion 51. Accordingly, for example, when the first fixing portion 62 and the second fixing portion 72 are welded, it is possible to preferably suppress a case in which the energy (heat, etc.) applied from the energy source (heat source, etc.) to the welded portion is applied to the electric wire member 20. As a result, damage to the electric wire member 20 can be suitably suppressed.

(6) The first fixing portion 62 overlaps with the second fixing portion 72 in a direction orthogonal to the protruding direction of the first fixing portion 62. According to this configuration, the first fixing portion 62 and the second fixing portion 72 are overlapped with each other in a direction not facing the inner space of the covering portion 51, and the overlapped first fixing portion 62 and the second fixing portion 72 are welded together. As a result, for example, when the first fixing portion 62 and the second fixing portion 72 are welded together, it is possible to more suitably suppress a case in which the energy applied from the energy source to the welded portion is applied to the electric wire member 20. As a result, damage to the electric wire member 20 can be more suitably suppressed.

(7) The joining portion 80 and the insertion port 42 of the first path restricting member 40 are provided so as not to overlap with each other in the radial direction of the covering portion 51. For this reason, the main body portion 41 of the first path restricting member 40 can be interposed between the wire harness main body 11 and the joining portion 80 in the radial direction of the covering portion 51. As a result, spattered materials that may be generated during welding, for example, can be received by the main body portion 41, and therefore damage to the wire harness main body 11 due to spattering can be suitably suppressed.

(8) A tightening margin is provided between the outer circumferential surface of the first path restricting member 40 and the inner circumferential surface of the covering portion 51. According to this configuration, the first path restricting member 40 is fitted to the inner circumferential surface of the covering portion 51 with a tightening margin. That is, when the first path restricting member 40 is fitted inside the covering portion 51, the outer circumferential surface of the first path restricting member 40 and the inner circumferential surface of the covering portion 51 come into contact with each other with a tightening margin. As a result, the first path restricting member 40 fitted inside the covering portion 51 is held in a state of being constantly pressed inward in the radial direction of the covering portion 51 by the inner surface of the covering portion 51. For this reason, rattling of the first path restricting member 40 inside the covering portion 51 can be suitably suppressed. As a result, for example, it is possible to suppress damage to the attachment portions of the first path restricting member 40 and the second path restricting member 50, and consequently, the path of the wire harness main body 11 can be stably restricted. Also, relative movement of the first path restricting member 40 with respect to the covering portion 51 in the lengthwise direction of the wire harness main body 11 can be suitably suppressed. As a result, in the lengthwise direction of the wire harness main body 11, it is possible to suitably suppress misalignment of the first path restricting member 40 with respect to the covering portion 51, and it is possible to suitably suppress detachment of the first path restricting member 40 from the covering portion 51.

(9) In the lengthwise direction of the wire harness main body 11, the first path restricting member 40 and the second path restricting member 50 are provided partially overlapping with each other. Specifically, in the lengthwise direction of the wire harness main body 11, the connecting portion 47 provided at the end portion in the lengthwise direction of the first path restricting member 40 and the covering portion 51 provided at the end portion in the lengthwise direction of the second path restricting member 50 are provided overlapping with each other. For this reason, the first path restricting member 40 and the second path restricting member 50 are connected in the lengthwise direction of the wire harness body 11. Accordingly, the path of the wire harness body 11 can be continuously restricted by the first path restricting member 40 and the second path restricting member 50.

(10) The first path restricting member 40 restricts the path of the straight section 11A, and the second path restricting member 50 restricts the path of the bent section 11B. This makes it possible to suppress a case in which the path of the straight section 11A and the path of the bent section 11B deviate from desired paths.

(11) The first path restricting member 40 has a protruding portion 45 that protrudes from the inner surface of at least one of the first end portion 43 and the second end portion 44 and can come into contact with the outer surface of the exterior member 30. With this protruding portion 45, for example, the exterior member 30 can be pressed from the outside of the exterior member 30. For this reason, detachment of the first path restricting member 40 from the exterior member 30 through the insertion port 42 can be suitably suppressed.

### Other Embodiments

The above embodiment can be modified and implemented as follows. The above embodiment and the following modifications can be implemented in combination with each other as long as no contradiction arises.

The structure of the covering portion 51 in the above embodiment can be changed as appropriate. For example, as long as the covering portion 51 has the receiving portion 60, the lid portion 70, and the joining portion 80, other structures are not particularly limited.

At least one of the two first fixing portions 62 may be omitted from the receiving portion 60 of the above embodiment.

At least one of the two second fixing portions 72 may be omitted from the lid portion 70 of the above embodiment.

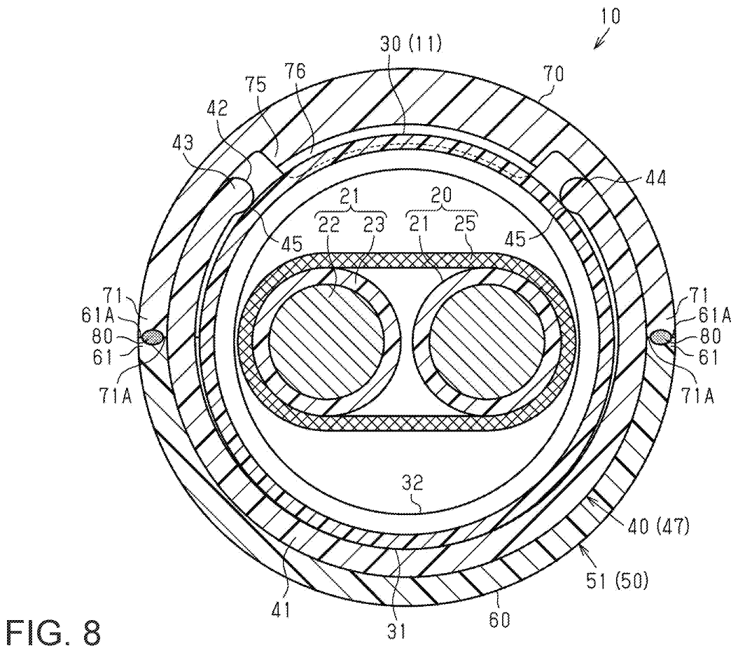

For example, as shown in FIG. 8, the end surfaces 61A on both sides in the circumferential direction of the receiving portion 60 and the end surfaces 71A on both sides in the circumferential direction of the lid portion 70 may be joined together. In the joining portion 80 of this modified example, the end surface 61A and the end surface 71A are joined together by welding. At this time, it is preferable that the joining portion 80 is provided so as not to overlap with the insertion port 42 of the first path restricting member 40 in the radial direction of the covering portion 51. In this modified example, the two first fixing portions 62 are omitted from the receiving portion 60, and the two second fixing portions 72 are omitted from the lid portion 70. For this reason, it is possible to suitably suppress an increase in the size of the covering portion 51 in the radial direction.

In the above embodiment, a tightening margin is provided between the inner circumferential surface of the covering portion 51 and the outer circumferential surface of the first path restricting member 40, but there is no limitation to this. For example, a tightening margin may not be provided between the inner circumferential surface of the covering portion 51 and the outer circumferential surface of the first path restricting member 40.

The structure of the receiving portion 60 in the above embodiment is not limited to a semi-cylindrical shape. The transverse cross-sectional shape of the inner surface of the receiving portion 60 is not limited to an arc shape, and can be changed to, for example, a U shape, an elliptical arc shape, or the like.

The structure of the lid portion 70 in the above embodiment is not limited to a semi-cylindrical shape. The transverse cross-sectional shape of the inner surface of the lid portion 70 is not limited to an arc shape, and can be changed to, for example, a U shape, an elliptical arc shape, or the like.

In the above embodiment, the projecting portion 75 was provided on the inner surface of the lid 70, but there is no limitation to this, and the projecting portion 75 may also be provided on the inner surface of the receiving portion 60. In this case, when the projecting portion 75 provided on the inner surface of the receiving portion 60 is inserted into the insertion port 42 of the first path restricting member 40, for example, the position in the circumferential direction of the insertion port 42 in the first path restricting member 40 is positioned so as to face the receiving portion 60 side of the covering portion 51.

The projecting portion 76 of the covering portion 51 may be omitted.

The protruding portion 75 of the cover 51 may be omitted.

The structure of the second path restricting member 50 in the above embodiment can be changed as appropriate. For example, as long as the second path restricting member 50 has the covering portion 51, other structures are not particularly limited.

The curved shape of the path restricting portion 52 can be changed as appropriate.

The transverse cross-sectional shape of the inner surface of the path restricting portion 52 is not limited to an arc shape, and can be changed to, for example, a U shape, an elliptical arc shape, or the like.

A lid connected to the path restricting portion 52 may be provided.

The second path restricting member 50 in the above embodiment was formed so as to restrict the path of the bent section 11B of the wire harness main body 11, but there is no limitation to this. For example, the second path restricting member 50 may be changed to a shape that restricts the path of the straight section 11A of the wire harness main body 11. The second path restricting member 50 in this case is changed, for example, to a shape in which the curved shape of the path restricting portion 52 extends linearly.

In the above embodiment, the attachment member (attachment) having the covering portion 51 was embodied as the second path restricting member 50, but there is no limitation to this. For example, the attachment member may be embodied as a structure having only the covering portion 51. For example, the attachment member may be embodied as a vehicle attachment member for attaching the first path restricting member 40 to the vehicle V.

The structure of the first path restricting member 40 in the above embodiment can be changed as appropriate. For example, as long as the first path restricting member 40 has the insertion port 42 and has a structure that can be attached to the outer circumferential surface of the exterior member 30, other structures are not particularly limited.

Each projecting portion 45 of the above embodiment may be provided at a position located farther away from the insertion port 42 than the first end portion 43 and the second end portion 44 in the circumferential direction of the first path restricting member 40.

Each projecting portion 45 may be partially provided in the lengthwise direction of the first path restricting member 40.

At least one of the two protruding portions 45 may be omitted.

The first path restricting member 40 may be provided with a second protruding portion that protrudes from the inner surface of the intermediate portion in the circumferential direction of the main body portion 41 and can come into contact with the outer surface of the exterior member 30. According to this configuration, the protruding portion 45 and the second protruding portion can be brought into contact with the outer surface of the exterior member 30 together. Therefore, rattling of the first path restricting member 40 can be suppressed.

In the first path restricting member 40, a groove extending along the lengthwise direction may be provided on the outer surface of the main body portion 41. According to this configuration, the main body portion 41 is easily deformed to the outer peripheral side using the groove as a starting point, whereby the insertion opening 42 can be more easily expanded. As a result, it is possible to contribute to the improvement of the assemblability of the first path restricting member 40.

The thickness in the radial direction of the main body portion 41 may be changed in the circumferential direction.

The transverse cross-sectional shape of the main body portion 41 is not limited to an arc shape, but can be changed to, for example, an elliptical arc shape, a U shape, or the like.

In the above-described embodiment, the first path restricting member 40 and the second path restricting member 50 were harder than the exterior member 30, but there is no limitation to this, and the hardness may be less than or equal to that of the exterior member 30. That is, if the first path restricting member 40 and the second path restricting member 50 act so that the wire harness main body 11 is less likely to bend than the wire harness main body 11 in the state where the first path restricting member 40 and the second path restricting member 50 are not attached, the first path restricting member 40 and the second path restricting member 50 need not be harder than the exterior member 30.

In the above embodiment, the second path restricting members 50 may be provided on both sides of the first path restricting member 40 in the lengthwise direction.

At least one of the restricting members 91 and 92 in the above embodiment may be omitted.

For example, the exterior member 30 in the above-described embodiment may be a resin corrugated tube with a metal layer that contains a metal material, formed on the outer surface thereof.

The exterior member 30 in the above-described embodiment is not limited to being a corrugated tube, and may be an exterior member that is not provided with an annular protrusion 31 or an annular recess 32, for example.

The exterior member 30 in the above-described embodiment may have a slit that extends in the lengthwise direction of the exterior member 30.

Although the electric wires 21 in the above-described embodiment are high-voltage electric wires, the present disclosure is not limited to such a configuration. For example, the electric wires 21 may be low-voltage electric wires.

In the electric wire member 20 in the above-described embodiment, an electromagnetic shield member is embodied as the braided member 25. However, the present disclosure is not limited to such a configuration. For example, the electromagnetic shield member in the electric wire member 20 may be embodied as a metal foil.

The braided member 25 of the electric wire member 20 in the above-described embodiment may be omitted.

In the above-described embodiment, the number of electric wires 21 included in the electric wire member 20 is two. However, the present disclosure is not limited to such a configuration. The number of electric wires 21 may be one or three or more.

The positional relationship between the inverter M1 and the high-voltage battery M2 in the vehicle V is not limited to that in the above-described embodiment, and may be changed as appropriate depending on the vehicle configuration.

In the above-described embodiment, a plurality of on-board devices to which the wire harness 10 is to be electrically connected are embodied as the inverter M1 and the high-voltage battery M2. However, the present disclosure is not limited to such a configuration. The plurality of on-board devices to which the wire harness 10 is to be electrically connected are not particularly limited as long as they are electric devices to be mounted in the vehicle V.

The embodiments disclosed herein are illustrative in all aspects and should not be considered restrictive. The scope of the present disclosure is indicated by the scope of claims, not the above-mentioned meaning, and is intended to include all modifications within the meaning and scope equivalent to the scope of claims.

What is claimed is:

1. A wire harness comprising:
a wire harness main body having an electric wire and an exterior tube that covers an outer circumferential surface of the electric wire;
a path restrictor that is attached to an outer circumferential surface of the exterior tube and restricts a path of the wire harness main body; and
an attachment attached to an outer circumferential surface of a portion in a lengthwise direction of the path restrictor, wherein:
the path restrictor includes a main body that covers a portion of the outer circumferential surface of the exterior tube, and an insertion port that is open in a direction orthogonal to a lengthwise direction of the main body and extends over an entire length in the lengthwise direction of the main body,
the path restrictor has a connection connected to the attachment,
the attachment has a cover that covers an outer circumferential surface of the connection,
the cover includes a receiver that covers a portion in a circumferential direction of the path restrictor, a lid that covers an entirety of the outer circumferential surface of the path restrictor together with the receiver, in the circumferential direction, and a joint at which the receiver and the lid are joined together, and
the receiver and the lid sandwich the path restrictor.

2. The wire harness according to claim 1,
wherein the joint is a portion at which the receiver and the lid are welded together.

3. The wire harness according to claim 2, wherein:
the receiver includes a first protrusion that protrudes outward in a radial direction of the cover from an end in a circumferential direction of the receiver,
the lid includes a second protrusion that protrudes outward in a radial direction of the cover from an end portion in a circumferential direction of the lid, and overlaps with the first protrusion, and
the joint is a portion at which the first protrusion and the second protrusion are welded together.

4. The wire harness according to claim 3,
wherein the first protrusion overlaps with the second protrusion in a direction orthogonal to a protruding direction of the first protrusion.

5. The wire harness according to claim 2,
wherein the joint is portions at which end surfaces on both sides in the circumferential direction of the receiver and end surfaces on both sides in the circumferential direction of the lid are welded together.

6. The wire harness according to claim 2,
wherein the joint is provided so as not to overlap with the insertion port and so as to overlap with the main body in the radial direction of the cover.

7. The wire harness according to claim 1,
wherein a tightening margin is provided between the outer circumferential surface of the path restrictor and an inner circumferential surface of the cover.

8. The wire harness according to claim 1, wherein:
the path restrictor is a first path restrictor.
the attachment is a second path restrictor that is attached to the outer circumferential surface of the exterior tube and restricts the path of the wire harness main body,
the connection is provided at an end in a lengthwise direction of the first path restrictor, and
the cover is provided at an end in a lengthwise direction of the second path restrictor.

9. The wire harness according to claim 8, wherein:
the first path restrictor restricts a path of a straight section, which is a portion with a linear shape in the path of the wire harness main body, and
the second path restrictor restricts a path of a bend, which is a portion that is bent in the path of the wire harness main body.
